(19) United States
(12) Patent Application Publication
(10) Pub. No.: US 2013/0149588 A1
(43) Pub. Date: Jun. 13, 2013

(54) ELECTROCHEMICAL CELLS COMPRISING CHELATE LIGANDS

(71) Applicants: Arnd GARSUCH, Ludwigshafen (DE); Daher Michael Badine, Mannheim (DE); Oliver Gronwald, Frankfurt (DE); Aleksei Volkov, Ludwigshafen (DE); Jordan Keith Lampert, Ludwigshafen (DE); Simon Schroedle, Ludwigshafen (DE); Klaus Leitner, Ludwigshafen (DE)

(72) Inventors: Arnd GARSUCH, Ludwigshafen (DE); Daher Michael Badine, Mannheim (DE); Oliver Gronwald, Frankfurt (DE); Aleksei Volkov, Ludwigshafen (DE); Jordan Keith Lampert, Ludwigshafen (DE); Simon Schroedle, Ludwigshafen (DE); Klaus Leitner, Ludwigshafen (DE)

(21) Appl. No.: 13/705,592

(22) Filed: Dec. 5, 2012

Related U.S. Application Data
(60) Provisional application No. 61/567,639, filed on Dec. 7, 2011.

(51) Int. Cl. H01M 2/16

(52) U.S. Cl. CPC H01M 2/1673
USPC 429/144; 429/231.95; 429/224; 564/248

(57) ABSTRACT

The present invention relates to electrochemical cells comprising
(A) at least one cathode comprising at least one lithium ion-containing transition metal compound,
(B) at least one anode, and
(C) at least one layer comprising
   (a) at least one chemical compound which comprises at least one organic radical which derives from an organic chelate ligand, and
   (b) optionally at least one binder.

The present invention further relates to the use of inventive electrochemical cells, and to lithium ion batteries comprising at least one inventive electrochemical cell.

The present invention relates to electrochemical cells comprising
(A) at least one cathode comprising at least one lithium ion-containing transition metal compound,
(B) at least one anode, and
(C) at least one layer comprising
   (a) at least one chemical compound which comprises at least one organic radical which derives from an organic chelate ligand, and
   (b) optionally at least one binder.

The present invention further relates to the use of inventive electrochemical cells, and to lithium ion batteries comprising at least one inventive electrochemical cell.

Storing energy has long been a subject of growing interest. Electrochemical cells, for example batteries or accumulators, can serve to store electrical energy. As of recently, what are called lithium ion batteries have attracted particular interest. They are superior to the conventional batteries in several technical aspects. For instance, they can be used to generate voltages unobtainable with batteries based on aqueous electrolytes.

In this context, an important role is played by the materials from which the electrodes are made, and especially the material from which the cathode is made.

In many cases, lithium-containing mixed transition metal oxides are used, especially lithium-containing nickel-cobalt-manganese oxides with layer structure, or manganese-containing spinels which may be doped with one or more transition metals. However a problem with many batteries remains that of cycling stability, which is still in need of improvement. Specifically in the case of those batteries which comprise a comparatively high proportion of manganese, for example in the case of electrochemical cells with a manganese-containing spinel electrode and a graphite anode, a severe loss of capacity is frequently observed within a relatively short time. In addition, it is possible to detect deposition of elemental manganese on the anode in cases where graphite anodes are selected as counterelectrodes. It is believed that these manganese nuclei deposited on the anode, at a potential of less than 1V vs. Li/Li⁺, act as a catalyst for a reductive decomposition of the electrolyte. This is also thought to involve irreversible binding of lithium, as a result of which the lithium ion battery gradually loses capacity.

WO 2009/033627 discloses a ply which can be used as separator for lithium ion batteries. It comprises a nonwoven and particles which are intercalated into the nonwoven and consist of organic polymers and possibly partly of inorganic material. Such separators can avoid short circuits caused by metal dendrites. However, WO 2009/033627 does not disclose any long-term cycling experiments.

WO 2009/103537 discloses a ply with a base structure having pores, and the ply further comprises a binder which has been crosslinked. In a preferred embodiment, the base structure has been at least partly filled with particles. The plies disclosed can be used as separators in batteries. In WO 2009/103537, however, no electrochemical cells comprising the plies described are produced or examined.

WO 2011/024149 discloses lithium ion batteries which comprise an alkali metal such as lithium between cathode and anode, which acts as a scavenger of unwanted by-products or impurities. Both in the course of production of secondary battery cells and in the course of later recycling of the spent cells, suitable safety precautions have to be taken due to the presence of highly reactive alkali metal.

It was thus an object of the present invention to provide electrical cells which have an improved lifetime and in which, even after several cycles, no deposition of elemental manganese is observed, or in the course of whose production it is possible to use a scavenger which has a lower level of safety problems than the alkali metals and prolongs the lifetime of the cell to the desired degree.

This object is achieved by an electrochemical cell defined at the outset, which comprises
(A) at least one cathode comprising at least one lithium ion-containing transition metal compound,
(B) at least one anode, and
(C) at least one layer comprising
   (a) at least one chemical compound which comprises at least one organic radical which derives from an organic chelate ligand, and
   (b) optionally at least one binder.

The cathode (A) comprises at least one lithium ion-containing transition metal compound, for example the transition metal compounds LiCoO₂, LiFePO₄ or lithium-manganese spinel which are known to the person skilled in the art in lithium ion battery technology. The cathode (A) preferably comprises, as the lithium ion-containing transition metal compound, a lithium ion-containing transition metal oxide which comprises manganese as the transition metal.

Lithium ion-containing transition metal oxides which comprise manganese as the transition metal are understood in the context of the present invention to mean not only those oxides which have at least one transition metal in cationic form, but also those which have at least two transition metal oxides in cationic form. In addition, in the context of the present invention, the term “lithium ion-containing transition metal oxides” also comprises those compounds which—as well as lithium—comprise at least one non-transition metal in cationic form, for example aluminum or calcium.

In a particular embodiment, manganese may occur in cathode (A) in the formal oxidation state of +4. Manganese in cathode (A) more preferably occurs in a formal oxidation state in the range from +3.5 to +4.

Many elements are ubiquitous. For example, sodium, potassium and chloride are detectable in certain very small proportions in virtually all inorganic materials. In the context of the present invention, proportions of less than 0.1% by weight of cations or anions are disregarded. Any lithium ion-containing mixed transition metal oxide comprising less than 0.1% by weight of sodium is thus considered to be sodium-free in the context of the present invention. Any lithium ion-containing mixed transition metal oxide comprising less than 0.1% by weight of sulfate ions is thus considered to be sulfate-free in the context of the present invention.

In one embodiment of the present invention, lithium ion-containing transition metal oxide is a mixed transition metal oxide comprising not only manganese but at least one further transition metal.

In one embodiment of the present invention, lithium ion-containing transition metal compound is selected from manganese-containing lithium iron phosphates and preferably from manganese-containing spinels and manganese-containing transition metal oxides with layer structure, especially manganese-containing mixed transition metal oxides with layer structure.

In one embodiment of the present invention, lithium ion-containing transition metal compound is selected from those compounds having a superstoichiometric proportion of lithium.

In one embodiment of the present invention, manganese-containing spinels are selected from those of the general formula (I)

LiₐM¹_{b}Mn_{3-a-b}O_{4-d} (I)

where the variables are each defined as follows:

0.9≦a≦1.3, preferably 0.95≦a≦1.15,

0≦b≦0.6, for example 0.0 or 0.5,

where, in the case that M¹ selected=Ni, preferably: 0.4≦b≦0.55,

−0.1≦d≦0.4, preferably 0≦d≦0.1.

M¹ is selected from one or more elements selected from Al, Mg, Ca, Na, B, Mo, W and transition metals of the first period of the Periodic Table of the Elements. M¹ is preferably selected from Ni, Co, Cr, Zn, Al, and M¹ is most preferably Ni.

In one embodiment of the present invention, manganese-containing spinels are selected from those of the formula LiNi_{0.5}Mn_{1.5}O_{4-d} and LiMn₂O₄.

In another embodiment of the present invention, manganese-containing transition metal oxides with layer structure are selected from those of the formula (II)

Li₁₊ₜM²₁₋ₜO₂ (II)

where the variables are each defined as follows:

0≦t≦0.3 and

M² is selected from Al, Mg, B, Mo, W, Na, Ca and transition metals of the first period of the Periodic Table of the Elements, the transition metal or at least one transition metal being manganese.

In one embodiment of the present invention, at least 30 mol % of M² is selected from manganese, preferably at least 35 mol %, based on the total content of M².

In one embodiment of the present invention, M² is selected from combinations of Ni, Co and Mn which do not comprise any further elements in significant amounts.

In another embodiment, M² is selected from combinations of Ni, Co and Mn which comprise at least one further element in significant amounts, for example in the range from 1 to 10 mol % of Al, Ca or Na.

In one embodiment of the present invention, manganese-containing transition metal oxides with layer structure are selected from those in which M² is selected from Ni_{0.33}Co_{0.33}Mn_{0.33}, Ni_{0.5}Co_{0.2}Mn_{0.3}, Ni_{0.4}Co_{0.3}Mn_{0.4}, Ni_{0.4}Co_{0.2}Mn0.4 and Ni_{0.45}Co_{0.10}Mn_{0.45}.

In one embodiment, lithium-containing transition metal oxide is in the form of primary particles agglomerated to spherical secondary particles, the mean particle diameter (D50) of the primary particles being in the range from 50 nm to 2 μm and the mean particle diameter (D50) of the secondary particles being in the range from 2 μm to 50 μm.

Cathode (A) may comprise one or further constituents. For example, cathode (A) may comprise carbon in a conductive polymorph, for example selected from graphite, carbon black, carbon nanotubes, graphene or mixtures of at least two of the aforementioned substances.

In addition, cathode (A) may comprise one or more binders, for example one or more organic polymers. Suitable binders are, for example, organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene, especially styrene-butadiene copolymers. Polypropylene is also suitable. Polyisoprene and polyacrylates are additionally suitable. Particular preference is given to polyacrylonitrile.

Polyacrylonitrile is understood in the context of the present invention to mean not only polyacrylonitrile homopolymers, but also copolymers of acrylonitrile with 1,3-butadiene or styrene. Preference is given to polyacrylonitrile homopolymers.

In the context of the present invention, polyethylene is understood to mean not only homopolyethylene but also copolymers of ethylene which comprise at least 50 mol % of ethylene in copolymerized form and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is understood to mean not only homopolypropylene but also copolymers of propylene which comprise at least 50 mol % of propylene in copolymerized form and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is understood to mean not only homopolymers of styrene but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethylcellulose, polyimides and polyvinyl alcohol.

In one embodiment of the present invention, binders are selected from those (co)polymers which have a mean molecular weight M_{w} in the range from 50 000 to 1 000 000 g/mol, preferably to 500 000 g/mol.

Binders may be crosslinked or uncrosslinked (co)polymers.

In a particularly preferred embodiment of the present invention, binders are selected from halogenated (co)polymers, especially from fluorinated (co)polymers. Halogenated or fluorinated (co)polymers are understood to mean those (co)polymers comprising, in copolymerized form, at least one (co)monomer having at least one halogen atom or at least one fluorine atom per molecule, preferably at least two halogen atoms or at least two fluorine atoms per molecule.

Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

In addition, cathode (A) may have further constituents customary per se, for example an output conductor, which may be configured in the form of a metal wire, metal grid, metal mesh, expanded metal, metal sheet or metal foil. Suitable metal foils are especially aluminum foils.

In one embodiment of the present invention, cathode (A) has a thickness in the range from 25 to 200 μm, preferably from 30 to 100 μm, based on the thickness without output conductor.

Inventive electrochemical cells further comprise at least one anode (B).

In one embodiment of the present invention, anode (B) can be selected from anodes composed of carbon and anodes comprising Sn or Si. Anodes composed of carbon can be selected, for example, from hard carbon, soft carbon, graphene, graphite, and especially graphite, intercalated graphite and mixtures of two or more of the aforementioned carbons. Anodes comprising Sn or Si can be selected, for example, from nanoparticulate Si or Sn powder, Si or Sn fibers, carbon-Si or carbon-Sn composite materials, and Si-metal or Sn-metal alloys.

Anode (B) may have one or more binders. The binder selected may be one or more of the aforementioned binders specified in the context of the description of cathode (A).

In addition, anode (B) may have further constituents customary per se, for example an output conductor which may be configured in the form of a metal wire, metal grid, metal mesh, expanded metal, or metal foil or metal sheet. Suitable metal foils are especially copper foils.

In one embodiment of the present invention, anode (B) has a thickness in the range from 15 to 200 μm, preferably from 30 to 100 μm, based on the thickness without output conductor.

Inventive electrochemical cells further comprise (C) at least one layer, also called layer (C) for short, which comprises (a) at least one chemical compound, also called compound (a) for short, which comprises at least one organic radical which derives from an organic chelate ligand, and which comprises (b) optionally at least one binder, also called binder (b) for short.

The chemical compound present in layer (C) may, for example, be an organic chelate ligand itself or preferably an organic or inorganic polymer, in which case this organic or inorganic polymer comprises at least one organic radical which derives from an organic chelate ligand.

In a preferred embodiment of the present invention, in the inventive electrochemical cell, the chemical compound present in layer (C) is an organic or inorganic polymer, which is also referred to hereinafter as polymer (a) for short.

Polymer (a), which may be organic or inorganic in nature, is known in principle to the person skilled in the art. Preferably, polymer (a) is selected from those polymers which do not lead to unwanted side reactions with the other components of the electrochemical cell with which they can come into contact, for example the liquid electrolyte, i.e. at least one organic solvent and the ions of the at least one conductive salt. Side reactions generally have an adverse effect on the cycling stability and the capacity of the electrochemical cell. Suitable polymers are already used, for example, as a constituent of separators in batteries or as binders in electrodes for electrochemical cells. The preferred polymers (a) are insoluble at room temperature in the liquid electrolyte of the electrochemical cell.

In a preferred embodiment of the present invention, in the inventive electrochemical cell, the chemical compound present in layer (C) is selected from the group consisting of polyvinylpyrrolidone, polyimide, polytetrafluoroethylene, polyvinylidene fluoride, melamine-formaldehyde resins, polysulfones, polyether sulfones and substituted styrene-divinylbenzene copolymers, and also SiO₂, Al₂O₃, TiO₂, ZrO₂ and mixtures thereof.

According to the properties of the organic or inorganic polymer which has been discussed above and is present in layer (C), this polymer may be present in layer (C) in different forms. An inorganic polymer such as SiO₂ (for example silica gel), Al₂O₃, TiO₂, ZrO₂ and mixtures thereof is typically present in particulate form. In principle, it is also possible to use suitable starting compounds to produce silicon dioxide in the form of thin layers, i.e. as films, although such a film must also have pores through which electrolyte fluid and lithium cations can migrate without hindrance. An organic polymer such as polyvinylpyrrolidone, polyimide, polytetrafluoroethylene, polyvinylidene fluoride, melamine-formaldehyde resins, polysulfones, polyether sulfones and substituted styrene-divinylbenzene copolymers can, according to the profile of properties, be incorporated into layer (C) in different forms. An insoluble organic polymer such as crosslinked styrene-divinylbenzene copolymer is preferably incorporated into layer (C) in the form of particles, while a corresponding soluble polymer can be processed to a film, for example a polyether sulfone, or else can be applied homogeneously in layer (C), for example on or in a carrier material, which again may be of organic or inorganic origin.

In the cases in which an organic chelate ligand is itself the chemical compound present in layer (C), the organic chelate ligand, which is preferably a low molecular weight compound, meaning preferably a compound having a molar mass of less than 2000 g/mol, more preferably having a molar mass of 60 g/mol to 1000 g/mol, may be present in layer (C) in different forms. According to the solubility properties of the chelate ligand in the electrolyte fluid, it may be completely, substantially or barely dissolved therein, and hence be present in layer (C) in homogeneous distribution and/or in particulate form.

In one embodiment of the present invention, in the inventive electrochemical cells, the chemical compound present in layer (C), more particularly the organic or inorganic polymer present in layer (C), is in particulate form, in the form of a film or is present in homogeneous distribution in layer (C). Preferably, the polymer present in layer (C) is in particulate form. Organic or inorganic polymers in particulate form may, in the context of the present invention, have a mean particle diameter (D50) in the range from 0.05 to 100 μm. Organic polymers preferably have a mean particle diameter (D50) in the range from 0.5 to 10 μm, more preferably 2 to 6 μm. Inorganic polymers preferably have a mean particle diameter (D50) in the range from 0.05 to 5.0 μm, more preferably 0.1 to 2 μm.

The organic radical present in the chemical compound, more particularly in the organic or inorganic polymer, derives from an organic chelate ligand.

An organic radical in the context of the present invention is understood to mean one which derives from an organic compound in each case. For instance, three different organic radicals having one carbon atom derive in principle from the organic compound methanol, namely methyl (H₃C—), methoxy (H₃C—O—) and hydroxymethyl (HOC(H₂)—). The organic radical should accordingly be regarded as a substructure of the parent organic starting compound. The organic radical preferably has the same linkage of carbon atoms (carbon skeleton) as the organic compound serving as the starting point; more particularly, the organic radical has the same number of carbon atoms as the organic compound.

Organic chelate ligands possess two or more coordination sites for metal cations, and it is preferably possible in each case for two coordination sites of the organic chelate ligand, together with a metal cation, preferably a transition metal cation, to form a strain-free 5- or 6-membered ring. Such metal complexes are referred to as chelate complexes. In the chelate complex, the organic chelate ligand itself may be present as an uncharged constituent, for example 2,2′-bipyridine, or in singly or multiply deprotonated form, for example as oxinate or tartrate.

In a preferred embodiment of the present invention, in the inventive electrochemical cell, the organic radical present in the chemical compound, more particularly in the organic or inorganic polymer, derives from an organic chelate ligand selected from the group of chelate ligands consisting of acetylacetone and salts thereof, salicylimide and salts thereof, N,N′-ethylenebis(salicylimine) and salts thereof, ethylenediamine, 2-(2-aminoethylamino)ethanol, diethylenetriamine, iminodiacetic acid and salts thereof, triethylenetetramine, triaminotriethylamine, nitrilotriacetic acid and salts thereof, ethylenediaminotriacetic acid and salts thereof, ethylenediaminetetraacetic acid and salts thereof, diethylenetriaminepentaacetic acid and salts thereof, 1,4,7,10-tetraazacyclododecane-1,4,7,10-tetraacetic acid and salts thereof, oxalic acid and salts thereof, tartaric acid and salts thereof, citric acid and salts thereof, dimethylglyoxime, 8-hydroxyquinoline and salts thereof, dimercaptosuccinic acid and salts thereof, 2,2′-bipyridine, 1,10-phenanthroline and substituted derivatives thereof, i.e derivatives of all abovementioned chelate ligands.

Preference is given in accordance with the invention to polydentate chelate ligands which can form more than one strain-free 5- or 6-membered ring with a metal ion, especially a multiply charged transition metal ion, for example Mn²⁺. Particular preference is given to tetradentate chelate ligands, especially those of the salen type with the N,N′-ethylenebis(salicylimine) base structure.

Many of the chelate ligands possess acidic protons which can be deprotonated by appropriate bases, for example alkali metal hydroxides, for example lithium hydroxide or sodium hydroxide, alkali metal hydrides, for example lithium hydride or sodium hydride, or alkyl alkali metal compounds, for example methyl- or butyllithium. The acidic protons of the chelate ligands may originate, for example, from carboxyl groups (—COOH), as in the case of ethylenediaminetetraacetic acid, or hydroxyl groups (—OH), as in the case of salicylimides. Doubly negatively charged chelate ligands form uncharged complexes with doubly positively charged metal ions, and these can also be referred to as internal complexes. When lithiated chelate ligands are used, after the coordination of multiply charged transition metal ions, singly charged lithium ions are released, and these in lithium ion cells ensure the charge transport required.

In a further preferred embodiment of the present invention, in the inventive electrochemical cell, the organic radical present in the chemical compound, more particularly in the organic or inorganic polymer, derives from an organic chelate ligand in which one or more acidic protons have been exchanged for lithium cations.

As described above, the chemical compound, more particularly the organic or inorganic polymer, comprises at least one organic radical which derives from an organic chelate ligand.

In one embodiment of the present invention, the organic radical which derives from an organic chelate ligand, also called chelate ligand radical hereinafter for short, is bonded covalently to the chemical compound, more particularly the organic or inorganic polymer. The linkage between chelate ligand radical and chemical compound, more particularly organic or inorganic polymer, can be effected directly via at least one, preferably one, chemical bond or via at least one, preferably one, bonding element, called a linker, and the bonding element may be a di- or polyvalent atom, for example —O— or —Si(Me)₂-, or a di- or polyvalent organic group, for example —CH₂CH₂— or —O(C═O)O—.

In one variant, a suitably substituted chelate ligand or salt thereof can be bonded covalently to an organic or inorganic polymer which has optionally been synthesized provided with specific functional groups for the linkage. J. Am. Chem. Soc. 1999, 121, 4147-4154 discloses methods with which chiral salen ligands can be linked to a hydroxymethylpolystyrene, or supported covalently on silica gel. Catalysis Letters Vol. 81, No, 1-2, 89-96 describes the production of a silica gel bearing covalently bonded ethylenediaminetriacetic acid groups. Adv. Synth. Catal. 2006, 348, 1760-1771 mentions, in the introduction, a number of salen complexes supported on different polymers, which introduce different supporting concepts for the preparation of organic polymers which comprise at least one radical which derives from an organic chelate ligand. Langmuir, Vol. 23, No. 9, 2007, 5062-5069 describes the preparation of poly(N-salicylidenevinylamine) by reaction of polyvinylamine with salicylaldehyde.

In a further variant, a chelate ligand can also itself be incorporated into the main chain of a polymer, as shown in the case of a polymeric chiral salen ligand in J. Mol. Catal. A:Chem. 259 (2006), 125-132.

In a specific variant, as already described above, the chemical compound (a) may itself be a low molecular weight organic chelate ligand. In this case, the radical which derives from a chelate ligand is bonded covalently to the chemical compound, namely to the organic chelate ligand.

In a preferred embodiment of the present invention, in the inventive electrochemical cell, the organic radical which derives from an organic chelate ligand is bonded covalently to the chemical compound, more particularly covalently to the organic or inorganic polymer.

In a further embodiment of the present invention, the organic radical which derives from an organic chelate ligand is bonded by absorption to the chemical compound, more particularly to the organic or inorganic polymer. In this embodiment, the chelate ligand radical is part of an organic chelate ligand or part of a soluble polymer. Since organic chelate ligands generally comprise at least two polar groups, organic chelate ligands can preferably form strong interactions with polar organic or inorganic polymers, for example silica gels (SiO₂), melamine-formaldehyde resins, for example the foamed thermoset Basotect®, PVP in soluble or insoluble form, or else with the corresponding copolymers of vinylpyrrolidone, for example with vinyl acetate or with vinylcaprolactam. In this way, it is possible to bind organic chelate ligands by adsorption, i.e. without entering into covalent bonds, on a suitable organic or inorganic polymer. For example, the separators described in WO 2009/033627 or WO 2009/103537, which comprise particles of polar inorganic and/or organic polymers, for example silicon oxide, aluminum oxide or polyvinylpyrrolidone, can be treated with a solution of a chelate ligand, for example a salen derivative, for example by impregnation or spraying, in order to arrive at a modified separator with which an inventive electrochemical cell can be produced. For example, the separator described in example 2 of WO 2009/103537 can be treated with the solution of a chelate ligand, especially of a salen derivative.

In a further preferred embodiment of the present invention, in the inventive electrochemical cell, the organic radical which derives from an organic chelate ligand is bonded by absorption to the chemical compound, more particularly to the organic or inorganic polymer.

The proportion by weight of the chemical compound (a), more particularly of the polymer (a), in the total mass of layer (C) may be up to 100% by weight. Preferably, the proportion by weight of polymer (a) in the total mass of layer (C) is at least 5% by weight, more preferably 40 to 80% by weight; more particularly, the proportion by weight of polymer (a) in the total mass of layer (C) is in the range from 30 to 50% by weight.

The proportion by weight of the organic radical which derives from an organic chelate ligand may, in relation to the total mass of layer (C), likewise be up to 100% by weight. Preferably, the proportion by weight of the chelate ligand radical in the total mass of layer (C) is at least 1% by weight, more preferably 5 to 50% by weight; more particularly, the proportion by weight of the chelate ligand radical in the total mass of layer (C) is in the range from 10 to 30% by weight.

In one embodiment of the present invention, binder (b) is selected from those binders as described in connection with binder for the cathode(s) (A).

In a preferred embodiment of the present invention, in the inventive electrochemical cell, layer (C) comprises a binder (b) selected from the group of polymers consisting of polyvinyl alcohol, styrene-butadiene rubber, polyacrylonitrile, carboxymethylcellulose and fluorinated (co)polymers, especially selected from styrene-butadiene rubber and fluorinated (co)polymers.

In one embodiment of the present invention, binder (b) and binder for cathode and for anode, if present, are each the same.

In another embodiment, binder (b) differs from binder for cathode (A) and/or binder for anode (B), or binder for anode (B) and binder for cathode (A) are different.

In one embodiment of the present invention, layer (C) has a mean thickness in the range from 0.1 μm to 250 μm, preferably from 1 μm to 100 μm and more preferably from 9 μm to 50 μm.

Layer (C) is preferably a layer which does not conduct electrical current, i.e. an electrical insulator. On the other hand, layer (C) is preferably a layer which permits the migration of ions, especially of Li⁺ ions. Preferably, layer (C) is arranged spatially between cathode and anode within the inventive electrochemical cell.

In electrochemical cells, direct contact of the anode with the cathode, which causes a short circuit, is typically prevented by the incorporation of a separator.

In a further embodiment of the present invention, in the inventive electrochemical cells, layer (C) is a separator.

Layer (C) may, as well as the chemical compound (a) which comprises at least one organic radical which derives from an organic chelate ligand, and the optional binder (b), have further constituents, for example support material such as fibers or nonwovens, which ensure improved stability of layer (C), without impairing the necessary porosity and ion perviosity thereof. Alternatively or additionally, layer (C) may also comprise at least one porous polymer layer, for example a polyolefin membrane, especially a polyethylene or polypropylene membrane. Polyolefin membranes may in turn be formed from one or more layers. Porous polyolefin membranes or else nonwovens themselves may generally fulfill the function of a separator alone. Layer (C) may likewise comprise particles which are inorganic or organic in nature and which are specified, for example, in WO 2009/033627.

In one embodiment of the present invention, in the inventive electrochemical cells, layer (C) additionally comprises a nonwoven (c).

Nonwoven (c) may have been produced from inorganic or organic materials.

Examples of organic nonwovens are polyester nonwovens, especially polyethylene terephthalate nonwovens (PET nonwovens), polybutylene terephthalate nonwovens (PBT nonwovens), polyimide nonwovens, polyethylene and polypropylene nonwovens, PVdF nonwovens and PTFE nonwovens. Preference is given especially to PET nonwovens.

Examples of inorganic nonwovens are glass fiber nonwovens and ceramic fiber nonwovens.

According to the composition of layer (C), this may consist, for example, solely of the chemical compound (a) modified with chelate ligand radicals, for example in the form of a porous film, or of the modified chemical compound (a) in particulate form and a binder (b), or else of a polyester nonwoven with particles of the chemical compound (a) modified with chelate ligand radicals distributed homogeneously therein, the chemical compound preferably being an organic or inorganic polymer. In these cases, layer (C) may already itself be used as a separator in the inventive electrochemical cell and may thus cover the cathode (A) or the anode (B) on at least one side. In addition, a layer (C) may also be applied to a customarily usable battery separator, such as a porous polyolefin membrane or a nonwoven, such that layer (C) covers a separator on at least one side. Layer (C) may also be applied as a thin layer to cathode or anode, and the inventive electrochemical cell produced thereby may additionally comprise a porous polyolefin membrane as a separator. In a further variant, layer (C) may also consist substantially of particles of a polymer as carrier material, the polymer particles having been coated with the chemical compound (a) modified with chelate ligand radicals.

In a further embodiment of the present invention, in the inventive electrochemical cells, layer (C) covers the cathode (A) or a separator or the anode (B) on at least one side.

The present invention further provides for the use of a chemical compound which comprises at least one organic radical which derives from an organic chelate ligand for production of an electrochemical cell. The chemical compounds (a) modified correspondingly with organic chelate ligands, i.e. organic chelate ligands themselves, organic or inorganic polymers and electrochemical cells, have already been described above. The present invention thus further provides a process for producing an electrochemical cell comprising at least one cathode and at least one anode, in which at least one chemical compound which comprises at least one organic radical which derives from an organic chelate ligand is positioned, i.e. incorporated, in a layer (C) between cathode and anode. Various embodiments for the provision and composition of the modified chemical compound, more particularly of a modified organic or inorganic polymer, have been described above.

The present invention accordingly also provides for the use of an organic or inorganic polymer which comprises at least one organic radical which derives from an organic chelate ligand for production of an electrochemical cell. As stated above, an organic chelate ligand may be bonded by absorption to an organic or inorganic polymer, or organic radicals which derive from an organic chelate ligand are bonded covalently to an organic or inorganic polymer. The present invention also provides a process for producing an electrochemical cell comprising at least one cathode and at least one anode, in which at least one organic or inorganic polymer which comprises at least one organic radical which derives from an organic chelate ligand is positioned, i.e. incorporated, in a layer between cathode and anode. Various embodiments for the provision and composition of the modified organic or inorganic polymer have been described above.

The layer (C) present in the inventive electrochemical cell may, depending on its structure, also be produced as a semifinished product independently of the assembly of the inventive electrochemical cell, and be incorporated later by a battery manufacturer as part of an electrochemical cell, for example as a finished separator or together with a typical battery separator, such as a PET nonwoven or a porous polyolefin membrane, between cathode and anode in an electrochemical cell.

Inventive electrochemical cells may also have constituents customary per se, for example conductive salt, nonaqueous solvent, and also cable connections and housing.

In one embodiment of the present invention, inventive electrochemical cells comprise at least one nonaqueous solvent which may be liquid or solid at room temperature and is preferably liquid at room temperature, and which is preferably selected from polymers, cyclic or noncyclic ethers, cyclic or noncyclic acetals, cyclic or noncyclic organic carbonates and ionic liquids.

Examples of suitable polymers are especially polyalkylene glycols, preferably poly-C₁-C₄-alkylene glycols and especially polyethylene glycols. Polyethylene glycols may comprise up to 20 mol % of one or more C₁-C₄-alkylene glycols in copolymerized form. Polyalkylene glycols are preferably doubly methyl- or ethyl-capped polyalkylene glycols.

The molecular weight M_{w} of suitable polyalkylene glycols and especially of suitable polyethylene glycols may be at least 400 g/mol.

The molecular weight Mw of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dinnethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

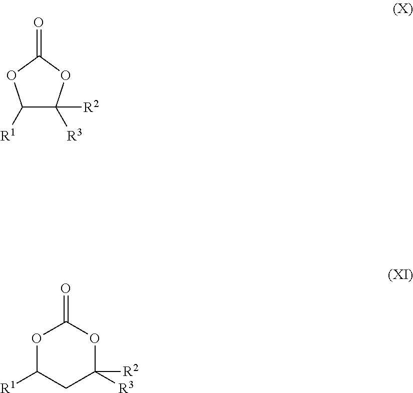

in which R¹, R² and R³ may be the same or different and are each selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

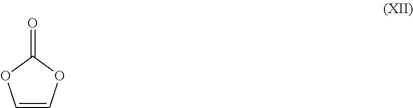

Preference is given to using the solvent(s) in what is called the anhydrous state, i.e. with a water content in the range from 1 ppm to 0.1% by weight, determinable, for example, by Karl Fischer titration.

Inventive electrochemical cells further comprise at least one conductive salt. Suitable conductive salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,

m=2 when X is selected from nitrogen and phosphorus, and

m=3 when X is selected from carbon and silicon.

Preferred conductive salts are selected from LiC(CF₃SO₂)₃, LiN(CF₃SO₂)₂, LiPF₆, LiBF₄, LiClO₄, and particular preference is given to LiPF₆ and LiN(CF₃SO₂)₂.

Inventive electrochemical cells further comprise a housing which may be of any shape, for example cuboidal or in the shape of a cylinder. In another embodiment, inventive electrochemical cells have the shape of a prism. In one variant, the housing used is a metal-plastic composite film processed as a pouch.

Inventive electrochemical cells give a high voltage of up to approx. 4.8 V and are notable for high energy density and good stability. More particularly, inventive electrochemical cells are notable for only a very small loss of capacity in the course of repeated cycling.

The present invention further provides for the use of inventive electrochemical cells in lithium ion batteries. The present invention further provides lithium ion batteries comprising at least one inventive electrochemical cell. Inventive electrochemical cells can be combined with one another in inventive lithium ion batteries, for example in series connection or in parallel connection. Series connection is preferred.

The present invention further provides for the use of inventive electrochemical cells as described above in automobiles, bicycles operated by electric motor, aircraft, ships or stationary energy stores.

The present invention therefore also further provides for the use of inventive lithium ion batteries in devices, especially in mobile devices. Examples of mobile devices are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The use of inventive lithium ion batteries in devices gives the advantage of prolonged run time before recharging and a smaller loss of capacity in the course of prolonged run time. If the intention were to achieve an equal run time with electrochemical cells with lower energy density, a higher weight for electrochemical cells would have to be accepted.

The invention is explained by the examples which follow, but these do not limit the invention.

Figures in % are each based on % by weight, unless explicitly stated otherwise.

I. Preparation of Chemical Compounds Modified with Chelate Ligand Radicals

### 1.1 Synthesis of N,N-bis(4-hydroxysalicylidene)ethylene-1,2-diamine

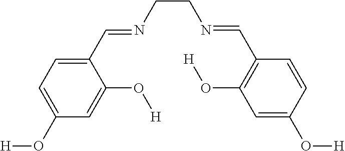 [SMILES: Oc1ccc(/C=N/CC/N=C/c2ccc(O)cc2O)c(O)c1]

Ethylenediamine (3.0 g, 50 mmol) was initially charged with ethanol (200 ml) in a 250 ml stirred apparatus with reflux condenser, thermometer, dropping funnel. 2,4-Dihydroxybenzaldehyde (13.8 g, 100 mmol) was added dropwise while stirring. This formed a yellow suspension. This suspension was stirred at RT for 3 days, then filtered with suction, and the residue was washed with ethanol and then suction-dried under reduced pressure, in order to obtain the product as a yellow powder (14.3 g, 95% yield).

| | C | H | N | O |
|---|---|---|---|---|
| found | 63.0 | 5.5 | 9.3 | 21.5 |
| theory | 63.99 | 5.37 | 9.33 | 21.31 |

¹H NMR (DMSO-d₆): δ=8.35 (s, 2H, HCN), 7.15 (d, 2H, ArH), 6.25 (d, 2H, ArH), 6.15 (s, 2H, ArH ortho), 3.75 (s, 4H, alk-H).

### I.2 Synthesis of tetralithium alkoxide from N,N-bis(4-hydroxysalicylidene)ethylene-1,2-diamine

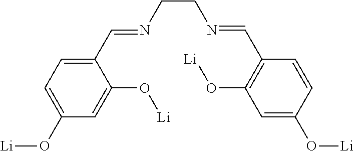

A 250 ml stirred flask with magnetic stirrer, reflux condenser, dropping funnel and thermometer was inertized thoroughly with argon. N,N-bis(4-Hydroxysalicylidene)ethylene-1,2-diamine (6.00 g, 20 mmol) from example 1.1 was initially charged in dry THF (200 ml) at −70° C. Butyllithium (1.6 M in n-hexane, 50 ml, 80 mmol) was slowly added dropwise while stirring. Subsequently, the mixture was left to come to RT overnight (18 h). The whole mixture was concentrated by evaporation and suction-dried under reduced pressure. The product isolated was 14.0 g of hygroscopic yellow-orange solid, which still comprised THF in the form of Li-THF complex.

¹H NMR (MeOD): δ=7.68 (s, 2H, HCN), 6.77 (d, 9 Hz, 2H, ArH), 5.95 (d, 9 Hz, 2H, ArH), 5.83 (s, 2H, ArH), 3.65 (s, 4H, alkylH); +3.72 (m, =THF), 1.86 (m=THF).

### I.3 Synthesis of dilithium alkoxide from N,N-bis(4-hydroxysalicylidene)ethylene-1,2-diamine

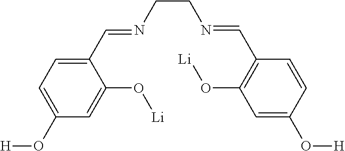

A 250 ml stirred flask with magnetic stirrer, reflux condenser, dropping funnel and thermometer was inertized thoroughly with argon. N,N-bis(4-Hydroxysalicylidene)ethylene-1,2-diamine (6.00 g, 20 mmol) from example 1.1 was initially charged in dry THF (200 ml) at −70° C. Butyllithium (1.6 M in n-hexane, 25 ml, 40 mmol) was slowly added dropwise while stirring. Subsequently, the mixture was left to come to RT overnight (18 h). The whole mixture was concentrated by evaporation and suction-dried under reduced pressure. The product isolated was 8.4 g of a yellow-orange solid, which still comprised THF in the form of Li-THF complex.

¹H NMR (MeOD): δ=7.68 (s, 2H), 6.82 (d, 9 Hz, 2H), 6.00 (d, 9 Hz, 2H), 3.69 (s, 4H); +3.72 (m, =THF), 1.86 (m=THF).

### I.4 Synthesis of an Unsymmetric Salen Ligand

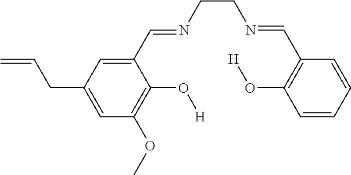 [SMILES: C=CCc1cc(/C=N/CC/N=C/c2ccccc2O)c(O)c(OC)c1]

3.0 g of ethylenediamine (50 mmol) and 6.6 g of ethylenediammonium dichloride (50 mmol) were initially charged in 150 ml of ethanol in a 500 ml stirred apparatus with reflux condenser, thermometer and dropping funnel. It was difficult here to get the dihydrochloride into solution. The suspension was then heated to 60° C., but the dihydrochloride did not dissolve completely. The suspension was diluted with a further 100 ml of ethanol and stirred at 60° C., but some crystals were still visible. This “solution” of monohydrochloride was admixed at RT with 6.1 g of salicylaldehyde (50 mmol) and stirred overnight. Added dropwise to the yellow suspension was a solution of 9.6 g of 5-allyl-2-hydroxy-3-methoxybenzaldehyde (50 mmol) and 10.1 g of triethylamine (100 mmol) in 100 ml of ethanol. The mixture was stirred overnight. The mixture was concentrated by evaporation on a rotary evaporator. A residue still moistened by solvent was obtained, which among other things also comprised triethylamine hydrochloride. The residue was admixed with 20 ml of water and extracted three times with 300 ml each time of toluene. The combined toluene phases were concentrated by evaporation on a rotary evaporator. 17.8 g of a red oil were obtained.

¹H NMR (acetonitrile-d3): δ=13.3-13.5 (d, 2H, ArOH), 8.45 (s, 1H, HCN), 8.35 (s, 1H, HCN), 7.10-7.35 (m, 4H, (2H ArH+2H impurity), 6.80-6.92 (m, 3H, ArH), 6.73 (s, 1H, ArH), 5.90-6.00 (m, 1H, —CH₂—CH═CH₂), 5.00-5.10 (t, 2H, —CH₂—CH═CH₂), 3.90 (t, 4H, alkylH), 3.78 (s, 3H, OCH₃), 3.30 (d, 2H, —CH₂—CH═CH₂).

### I.5 Synthesis of 3-allylpentane-2,4-dione

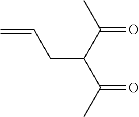

A 250 ml stirred apparatus with reflux condenser, thermometer and dropping funnel was initially charged with 40.5 g of a 30% solution of sodium methoxide in methanol (225 mmol) in 100 ml of methanol, and 20.0 g of acetylacetone (200 mmol) were added dropwise at approx. 5° C. The reaction mixture was left to come to room temperature. Subsequently, 40.3 g of allyl iodide (240 mmol) were added dropwise. The mixture was stirred at room temperature overnight. Monitoring of conversion by GC showed only a low level of reactants. The precipitate was filtered off and the filtrate was concentrated by evaporation down to about 100 ml. The solution was admixed with 1:1 MTBE-hexane, the precipitate formed was filtered off again and the solution was concentrated by evaporation again to about 100 ml. This operation was repeated with the 1:1:1 MTBE-hexane-heptane solvent mixture. Subsequently, the low boilers were distilled off using a short column at about 160 mbar. The product was distilled over at 32 mbar and 95-100° C. 7.8 g of product were obtained.

Product in tautomeric form (˜2:1 keto:enol), therefore visible in the NMR as a mixture.

¹H NMR (DMSO-de): δ=5.95-5.50 (m, 1H, HC═CH₂), 5.10-4.95 (m, 2H, HC═CH₂), 3.98 (t, ˜0.6H, CH(CO) keto), 3.00 (d, ˜0.7H, CH₂HC═CH₂ enol), 2.45 (t, ˜1.3H, CH₂HC═CH₂ keto), 2.17 (s, ˜4H, CH₃ keto), 2.10 (s, ˜2H, CH₃ enol).

II. Production of Inventive Separators

### II.1 Method for Production of an Inventive Separator (S.1)

1 g of the tetralithium salt of N,N-bis(4-hydroxysalicylidene)ethylene-1,2-diamine prepared in example I.2 is dissolved in 4 g of water. This solution is used to impregnate a separator based on crosslinked polyvinylpyrrolidone and a PET nonwoven (4 cm×8 cm; produced according to example 2 from WO2009/103537 A1) by a single immersion. The modified separator is dried under air overnight.

III. Production of Electrochemical Cells and Testing Thereof

The following electrodes are always used:

Cathode (A.1): lithium-nickel-manganese spinel electrodes are used, which are produced as follows. The following are mixed with one another in a screw-top vessel:

85% LiMn_{1.5}Ni_{0.5}O₄,

6% PVdF, commercially available as Kynar Flex® 2801 from the Arkema Group,

6% carbon black, BET surface area 62 m²/g, commercially available as “Super P Li” from Timcal,

3% graphite, commercially available as KS6 from Timcal.

While stirring, a sufficient amount of N-methylpyrrolidone is added to obtain a viscous paste free of lumps. The mixture is stirred for 16 hours.

Then the paste thus obtained is knife-coated onto 20 μm-thick aluminum foil and dried in a vacuum drying cabinet at 120° C. for 16 hours. The thickness of the coating after drying is typically 30 μm. Subsequently, disk-shaped segments with a diameter of 12 mm are punched out.

Anode (B.1): The following are mixed with one another in a screw-top vessel:

91% graphite, ConocoPhillips C5

6% PVdF, commercially available as Kynar Flex® 2801 from the Arkema Group,

3% carbon black, BET surface area 62 m²/g, commercially available as “Super P Li” from Timcal.

While stirring, a sufficient amount of N-methylpyrrolidone is added to obtain a viscous paste free of lumps. The mixture is stirred for 16 hours.

Then the paste thus obtained is knife-coated onto 20 μm-thick copper foil and dried in a vacuum drying cabinet at 120° C. for 16 hours. The thickness of the coating after drying is typically 35 μm. Subsequently, disk-shaped segments with a diameter of 12 mm are punched out.

The following electrolyte is always used:

1 M solution of LiPF₆ in anhydrous ethylene carbonate-ethyl methyl carbonate mixture (proportions by weight 1:1)

III.1 Method for Production of an Inventive Electrochemical Cell EC.1 and Testing

The inventive separator (S.1) produced according to II.1 is used as a separator and, for this purpose, electrolyte is dripped onto it in an argon-filled glovebox and it is positioned between a cathode (A.1) and an anode (B.1) such that both the anode and the cathode have direct contact with the separator. Electrolyte is added to obtain an inventive electrochemical cell EC.1. The electrochemical analysis is effected between 4.25 V and 4.8 V in an electrochemical cell.

The first two cycles are run at 0.2 C rate for the purpose of forming; cycles no. 3 to no. 50 are cycled at 1 C rate, followed again by 2 cycles at 0.2 C rate, followed by 48 cycles at 1 C rate, etc. The charging and discharging of the cell is performed with the aid of a “MACCOR Battery Tester” at room temperature.

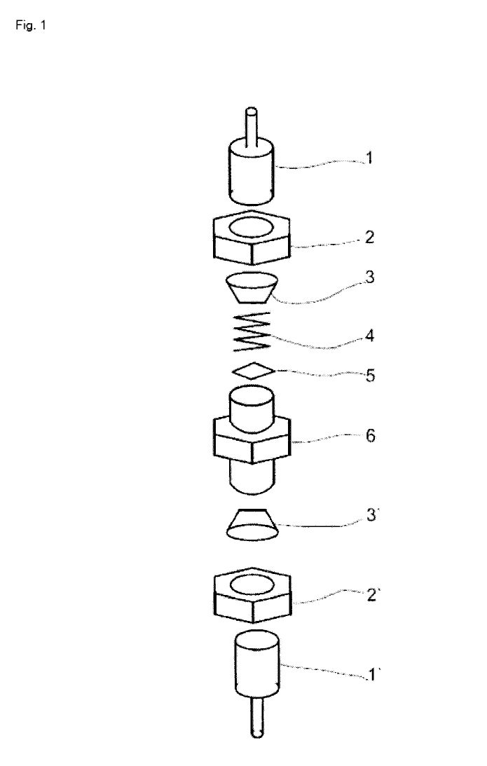

FIG. 1 shows the schematic structure of a dismantled electrochemical cell for testing of inventive and noninventive separators.

The annotations in FIG. 1 mean:

1, 1′ die

2, 2′ nut

3, 3′ sealing ring—two in each case, the second, somewhat smaller sealing ring in each case is not shown here

4 spiral spring

5 nickel output conductor

6 housing

1. An electrochemical cell comprising
(A) at least one cathode comprising at least one lithium ion-containing transition metal compound,
(B) at least one anode, and
(C) at least one layer comprising
(a) at least one chemical compound which comprises at least one organic radical which derives from an organic chelate ligand, and
(b) optionally at least one binder.

2. The electrochemical cell according to claim 1, wherein the lithium ion-containing transition metal compound present in cathode (A) is selected from manganese-containing spinels and manganese-containing transition metal oxides with layer structure.

3. The electrochemical cell according to claim 1 or 2, wherein anode (B) is selected from anodes composed of carbon and anodes comprising Sn or Si.

4. The electrochemical cell according to any of claims 1 to 3, wherein the chemical compound present in layer (C) is an organic or inorganic polymer.

5. The electrochemical cell according to any of claims 1 to 4, wherein the chemical compound present in layer (C) is selected from the group consisting of polyvinylpyrrolidone, polyimide, polytetrafluoroethylene, polyvinylidene fluoride, melamine-formaldehyde resins, polysulfones, polyether sulfones and substituted styrene-divinylbenzene copolymers, and also SiO₂, Al₂O₃, TiO₂, ZrO₂ and mixtures thereof.

6. The electrochemical cell according to any of claims 1 to 5, wherein the chemical compound present in layer (C) is in particulate form, in the form of a film or is present in homogeneous distribution in layer (C).

7. The electrochemical cell according to any of claims 1 to 6, wherein the organic radical present in the chemical compound derives from an organic chelate ligand selected from the group of chelate ligands consisting of acetylacetone and salts thereof, salicylimide and salts thereof, N,N′-ethylenebis(salicylimine) and salts thereof, ethylenediamine, 2-(2-aminoethylamino)ethanol, diethylenetriamine, iminodiacetic acid and salts thereof, triethylenetetramine, triaminotriethylamine, nitrilotriacetic acid and salts thereof, ethylenediaminotriacetic acid and salts thereof, ethylenediaminetetraacetic acid and salts thereof, diethylenetriaminepentaacetic acid and salts thereof, 1,4,7,10-tetraazacyclododecane-1,4,7,10-tetraacetic acid and salts thereof, oxalic acid and salts thereof, tartaric acid and salts thereof, citric acid and salts thereof, dimethylglyoxime, 8-hydroxyquinoline and salts thereof, dimercaptosuccinic acid and salts thereof, 2,2′-bipyridine, 1,10-phenanthroline and substituted derivatives thereof.

8. The electrochemical cell according to any of claims 1 to 7, wherein the organic radical present in the chemical compound derives from an organic chelate ligand in which one or more acidic protons have been exchanged for lithium cations.

9. The electrochemical cell according to any of claims 1 to 8, wherein the organic radical which derives from an organic chelate ligand is bonded covalently to the chemical compound.

10. The electrochemical cell according to any of claims 1 to 8, wherein the organic radical which derives from an organic chelate ligand is bonded by absorption to the chemical compound.

11. The electrochemical cell according to any of claims 1 to 10, wherein layer (C) comprises a binder (b) selected from the group of polymers consisting of polyvinyl alcohol, styrene-butadiene rubber, polyacrylonitrile, carboxymethylcellulose and fluorinated (co)polymers.

12. The electrochemical cell according to any of claims 1 to 11, wherein layer (C) has a mean thickness in the range from 9 to 50 μm.

13. The electrochemical cell according to any of claims 1 to 12, wherein layer (C) is a separator.

14. The electrochemical cell according to any of claims 1 to 13, wherein layer (C) additionally comprises a nonwoven (c).

15. The electrochemical cell according to any of claims 1 to 14, wherein layer (C) covers the cathode (A) or a separator or the anode (B) on at least one side.

16. The use of electrochemical cells according to any of claims 1 to 15 in lithium ion batteries.

17. A lithium ion battery comprising at least one electrochemical cell according to any of claims 1 to 15.

18. The use of electrochemical cells according to any of claims 1 to 15 in automobiles, bicycles operated by electric motor, aircraft, ships or stationary energy stores.

19. The use of a chemical compound which comprises at least one organic radical which derives from an organic chelate ligand for production of an electrochemical cell.

20. The use of an organic or inorganic polymer which comprises at least one organic radical which derives from an organic chelate ligand for production of an electrochemical cell.
